(19) United States
(12) Patent Application Publication
(10) Pub. No.: US 2019/0293099 A1
(43) Pub. Date: Sep. 26, 2019

(54) Rotationally-Constrainable Compensation Nut Fastener Assembly

(71) Applicant: ILLINOIS TOOL WORKS INC., Glenview, IL (US)

(72) Inventor: Clinton Eugene Pitt, Portland, TN (US)

(21) Appl. No.: 16/302,916

(22) PCT Filed: Mar. 31, 2017
(86) PCT No.: PCT/US2017/025277

§ 371 Date: Nov. 19, 2018

Related U.S. Application Data
(60) Provisional application No. 62/349,717, filed on Jun. 14, 2016.

(51) Int. Cl. F16B 5/02; F16B 37/04

(52) U.S. Cl. CPC F16B 5/0233; F16B 37/041

(57) ABSTRACT

A compensation nut fastener assembly (100) includes a first nut (102), a second nut (104) that is adjustably coupled to the first nut (102), and at least one first stop member (130) that is configured to cooperate with at least one second stop member of a component to rotationally constrain the first nut (102) relative to the component.

### RELATED APPLICATIONS

This application relates to and claims priority benefits from U.S. Provisional Patent Application No. 62/349,717 entitled “Compensation Nut Fastener Assembly,” filed Jun. 14, 2016, which is hereby incorporated by reference in its entirety.

### FIELD OF EMBODIMENTS OF THE DISCLOSURE

Embodiments of the present disclosure generally relate to fastener assemblies, and more particularly to compensation nut fastener assemblies that are configured to accommodate gaps between components, such as panels.

### BACKGROUND

In various industrial applications, components are connected together through the use of fasteners. Generally, fasteners are used to connect desired components, such as panels, together. In some applications, a gap may exist between the components. For example, two panels may be separated by a clearance area or gap in which portions of other components may reside. When connecting the panels together, a fastener assembly may rattle or slip within the gap, thereby generating undesired noise and providing a loose connection.

Additionally, in various applications, fasteners may be welded to components in order to provide a secure connection between the components. Typically, however, welding may be labor and time intensive, thereby adding time and cost to a manufacturing process.

Compensation nuts allow for tolerance adjustment, such as in automotive body applications, which may include rigid spacers or known stack-ups of cumulative tolerances in joints. Compensation nuts “compensate” (or “take up”) the tolerance in a joint at varying distances across a known range and create a rigid joint once a fastener is coupled thereto, seats, and fastens the joint.

Known compensation nuts include a top nut that contacts a mating joint surface at an unknown distance within a tolerance range of compensation, thereby allowing a fastener (such as a bolt or screw) to overcome the torque of the interference fit of the fastener and a plastic torque clip threading itself through the plastic and into the mating nut in the opposing panel. The fastener seats and fastens the joint at the same distance the top nut contacts the mating surface.

Notably, known compensation nuts are used with respect to two rigid mating surfaces of the joint so that the top nut stops upon contact, allowing the fastener to pass through and mate with the nut in the opposing panel, seat and fasten the joint. However, when the mating panels are not rigid (for example, semi-rigid or soft), the force applied by the compensation nut expanding can push the mating panels open further past the initial distance that appears in the joint. The expansion may cause larger gaps in between those surfaces than desired and cause alignment issues and unanticipated deformation in other areas surrounding that particular joint.

### SUMMARY OF EMBODIMENTS OF THE DISCLOSURE

A need exists for a compensation nut fastener assembly that securely and reliably connects to one or more components. A need exists for a compensation nut fastener that may be used to securely and reliably connect to one or more semi-rigid or soft components.

With those needs in mind, certain embodiments of the present disclosure provide a compensation nut fastener assembly that includes a first nut, a second nut that is adjustably coupled to the first nut, and at least one first stop member that is configured to cooperate with at least one second stop member of a component to rotationally constrain the first nut relative to the component. In at least one embodiment, the first nut includes the first stop member(s).

In at least one embodiment, the first nut includes a component-abutting collar. The first stop member may extend outwardly from the component-abutting collar. The first stop member(s) may be proximate to an outer edge of the component-abutting collar.

The first stop member(s) may include a root connected to a surface of the component-abutting collar, and a ramped segment extending from the root at an angle above the surface. The ramped segment includes a blunt leading end that connects to the surface. The first stop member(s) may include at least one lanced tab.

The first stop member(s) may include at least one protuberance, while the second stop member(s) may include at least one recess or at least one hole. Optionally, the first stop member(s) may include at least one recess or at least one hole, while the second stop member(s) may include at least one protuberance.

In at least one embodiment, the first stop member(s) is configured to rotate into engagement with the second stop member(s) to rotationally constrain the first nut relative to the component.

The first nut may include a fastener-receiving channel that is configured to receive a portion of a fastener. The first nut may be threadably coupled to the second nut, and the first nut may be configured to threadably retain a fastener.

Certain embodiments of the present disclosure provide a fastening system that includes a compensation nut fastener assembly and a component. The compensation nut fastener assembly includes a first nut, a second nut that is adjustably coupled to the first nut, and at least one first stop member. The component includes at least one second stop member. The first stop member(s) cooperates with the second stop member(s) to rotationally constrain the first nut relative to the component.

### BRIEF DESCRIPTION OF SEVERAL VIEWS OF THE DRAWINGS

FIG. 1 illustrates a perspective top view of a compensation nut fastener assembly, according to an embodiment of the present disclosure.

FIG. 2 illustrates a top view of a compensation nut fastener assembly, according to an embodiment of the present disclosure.

FIG. 3 illustrates a lateral view of a compensation nut fastener assembly in a closed position, according to an embodiment of the present disclosure.

FIG. 4 illustrates a lateral view of a compensation nut fastener assembly in an open position, according to an embodiment of the present disclosure.

FIG. 5 illustrates a bottom view of a compensation nut fastener assembly, according to an embodiment of the present disclosure.

FIG. 6 illustrates a bottom view of a component, according to an embodiment of the present disclosure.

FIG. 7 illustrates a bottom view of a component, according to an embodiment of the present disclosure.

FIG. 8 illustrates a lateral view of a protuberance extending from a first nut, according to an embodiment of the present disclosure.

FIG. 9 illustrates a lateral view of a protuberance extending from a first nut, according to an embodiment of the present disclosure.

FIG. 10 illustrates a top view of a first nut, according to an embodiment of the present disclosure.

FIG. 11 illustrates a top view of a first nut, according to an embodiment of the present disclosure.

FIG. 12 illustrates a lateral view of a component, according to an embodiment of the present disclosure.

FIG. 13 illustrates a lateral view of a first nut, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide compensation nut fastener assemblies that securely and reliably connect components together by compensating for a gap between the components. Embodiments of the present disclosure provide compensation nut fastener assemblies that are configured to provide a rotational stop, which rotationally constrains the compensation nut fastener assembly in position with respect to one or more components.

An example of a compensation nut fastener assembly is shown and described in U.S. Patent Application Publication No. 2015/0330427, entitled “Compensation Nut Fastener Assembly,” which is hereby incorporated by reference in its entirety. Embodiments of the present disclosure may be used with the compensation nut fastener assembly shown and described in U.S. Patent Application Publication No. 2015/0330427.

Embodiments of the present disclosure provide a compensation nut fastener assembly that includes a first or top nut having one or more protuberances, such as tabs, which may be formed through lancing (that is, lanced tabs). Centers of the tabs may be spaced 180 degrees from one another. The compensation nut fastener assembly may include a single protuberance, or two or more protuberances. Instead of tabs, various other protuberances may be used, such as studs, barbs, bumps, posts, columns, and/or the like.

The protuberances, such as lanced tabs, create interference and provide a rigid rotational stop when they abut into or otherwise contact an opposing surface, hole or recessed area of a component. For example, as the top nut is urged into an opposing surface of a component, the lanced tabs may rotate over a surface thereof. As the upturned tabs are rotated into the recessed areas (or holes), at least portions of the tabs (such as blunt leading edges) extend into the recessed areas. The recessed areas retain the tabs, thereby providing a barrier or stop past which the tabs are unable to further rotate. Accordingly, the interaction between the tabs and the recessed areas resist further rotation, and therefore provides a rotational stop.

The tabs in the top nut introduce a rotational stop upon contact with the mating panel, and allow a fastener (such as a screw or bolt) to overcome the torque caused by the interference fit between the fastener and plastic torque clip. The positive stop of the top nut may be provided 90 degrees from a direction of fastener installation and prevents, minimizes, or otherwise reduces further expansion of the compensation nut assembly. As such, embodiments of the present disclosure provide compensation nut fastener assemblies that may be used in semi-rigid panel applications such as plastic and/or in which mating panels have potential to move, thereby maintaining the original joint tolerance distance between the two mating surfaces, and eliminating, minimizing, or reducing unforeseen or unwanted misalignment and/or deformation.

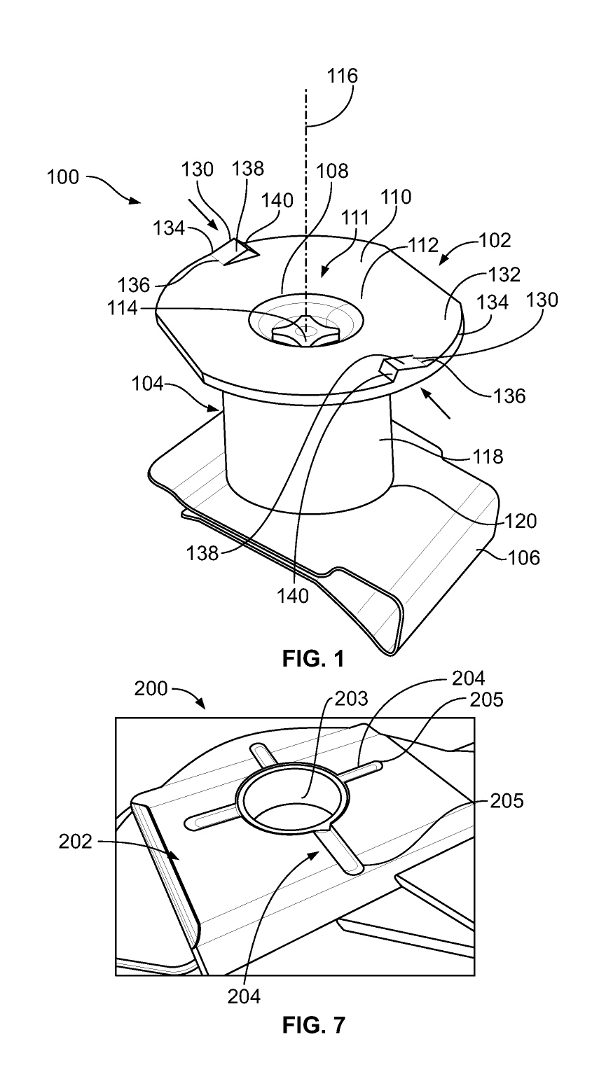

FIG. 1 illustrates a perspective top view of a compensation nut fastener assembly 100, according to an embodiment of the present disclosure. The compensation nut fastener assembly 100 includes a first, male, or top (as shown in FIG. 1) nut 102 that is adjustably secured to a second, female, or bottom (as shown in FIG. 1) nut 104. The second nut 104 may connect to a clip base 106. Optionally, the second nut 104 may not be connected to the clip base 106.

The first nut 102 may be formed of metal, plastic, or the like, and includes a shaft 108 integrally connected and formed with a radial component-abutting collar 110. A fastener-receiving channel 111 is formed through the shaft 108 and the collar 110. The collar 110 may be a planar, annular sheet of material that outwardly and radially extends from a fastener-receiving end 112 of the shaft 108. Threads may extend over an outer surface of the shaft 108 from below the collar 110 towards a fastener-passage end. A distal portion of the fastener-passage end may not be threaded. Instead, the distal portion may be peened, for example. The threads may extend over more than half of the shaft 108. For example, the threads may extend over 75% of the length of the shaft 108. Alternatively, the threads may extend over more or less of the shaft 108 than shown. For example, the threads may extend over an entire length of the shaft 108 from below the collar 110 to a distal tip.

The fastener-receiving channel 111 is formed through the first nut 102 from and through the fastener-receiving end 112 and through the distal tip. The fastener-receiving channel 111 longitudinally extends through the first nut 102 and may generally be centered about a longitudinal axis 116 of the first nut 102. The shaft 108 may include internal threading configured to threadably engage a fastener within the fastener-receiving channel 111. The fastener-receiving channel 111 is configured to receive a fastener, such as a bolt (not shown).

The compensation nut fastener assembly 100 may also include a torque clip 114 inserted within the fastener-receiving channel 111 of the first nut 102. The torque clip 114 is configured to center and hold a fastener, such as a bolt or screw, as the fastener is inserted into the fastener-receiving channel 111. The torque clip 114 ensures that the fastener remains in place and does not dislodge from the first nut 102. The torque clip 114 may be a plastic sleeve used to grip a fastener during an installation process. An example of the torque clip 114 is further described in U.S. Pat. No. 5,395,194, entitled “Convoluted Bolt Retainer,” which is hereby incorporated by reference in its entirety. Alternatively, the compensation nut fastener assembly 100 may not include the torque clip 114.

The second nut 104 may be formed of metal, plastic, or the like, and includes a circumferential retaining wall 118 that may connect to a lower panel-abutting collar 120 that radially extends from the retaining wall 118. The retaining wall 118 defines a central passage. Internal surfaces of the retaining wall 118 may include threads that are configured to threadably engage the threads of the first nut 102.

The first nut 102 includes at least one rotationally-constraining stop member, such as a protuberance 130 outwardly extending from an exposed upper (as shown in FIG. 1) surface 132 of the collar 110. As shown in FIG. 1, the first nut 102 includes two protuberances 130, which are generally spaced 180 degrees apart. For example, centers of the protuberances 130 may be spaced 180 degrees from one another. The protuberances 130 may be upturned tabs, which may be formed through lancing (that is, lanced tabs). In at least one other embodiment, the protuberances 130 may be studs, barbs, bumps, semispherical protrusions, and/or the like. While FIG. 1 shows two opposed protuberances 130, the compensation nut fastener assembly 100 may optionally include a single protuberance, or more than two protuberances 130. Instead of tabs, various other protuberances may be used, such as studs, barbs, bumps, clasps, and/or the like.

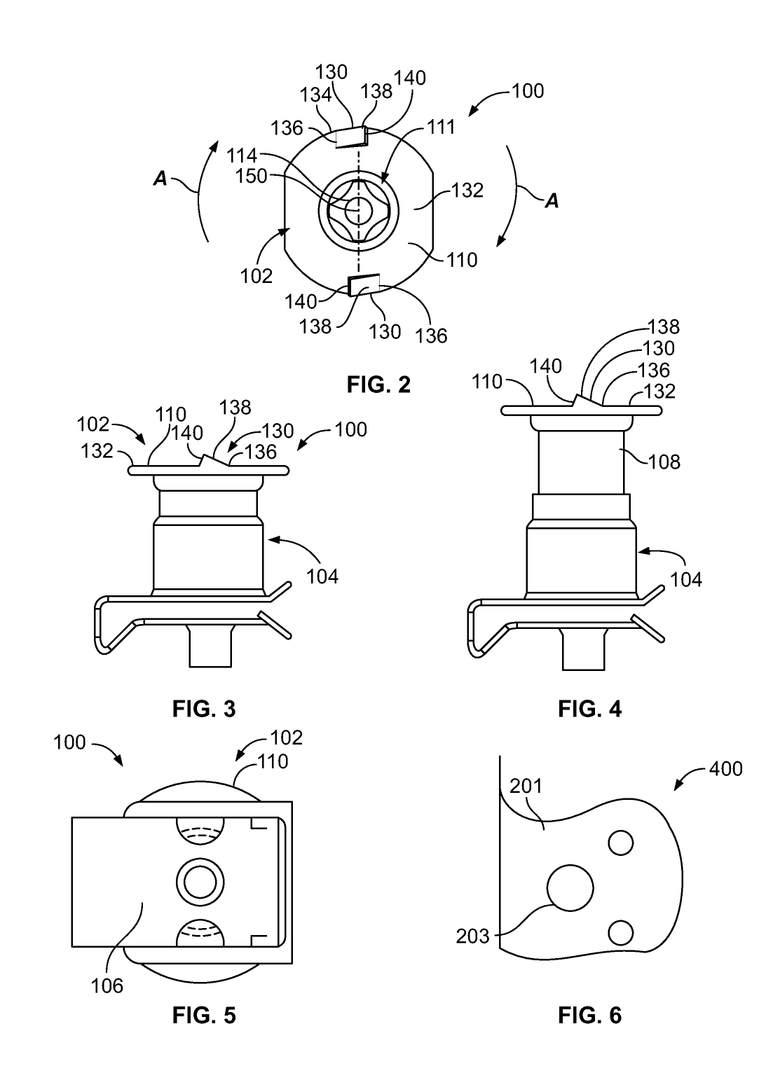

FIG. 2 illustrates a top view of the compensation nut fastener assembly 100. Referring to FIGS. 1 and 2, the protuberances 130 may upwardly extend from the collar 110 proximate to an outer edge 134. Bu positioning the protuberances 130 proximate to the outer edge 134, the protuberances 130 are not susceptible to undesirably interfering with a fastener (which may include a bolt head) that is configured to pass into the fastener-receiving channel 111. Optionally, the protuberances 130 may be inwardly disposed from the outer edge 134. Further, the protuberances 130 may provide ridges that extend from the outer edge 134 to or proximate to the fastener-receiving channel 111.

Each protuberance 130 may be an upturned, lanced tab that includes a root 136 that connects to the surface 132. A ramped segment 138 upwardly extends from the root 136 at an angle above the surface 132. The ramped segment 138 may terminate at a blunt leading end 140, which may reconnect to the surface 132, such as at a perpendicular connection. Optionally, the blunt end 140 may connect to the surface 132 at a non-perpendicular angle.

The protuberances 130 may be inversely oriented, such that the blunt leading ends 140 are disposed on opposite sides of central longitudinal (or lateral) plane 150. As such, when the first nut 102 is rotated in the direction of arcs A, each blunt leading end 140 leads into a respective stop member (such as a recess, hole, or barrier) of a component, as described herein.

FIG. 3 illustrates a lateral view of the compensation nut fastener assembly 100 in a closed position. FIG. 4 illustrates a lateral view of the compensation nut fastener assembly 100 in an open position. As shown in FIGS. 3 and 4, the first nut 102 is configured to contract into (as shown in FIG. 3) and extend outwardly from (as shown in FIG. 4) the second nut 104.

FIG. 5 illustrates a bottom view of the compensation nut fastener assembly 100. As indicated, the compensation nut fastener assembly 100 may or may not include the clip base 106.

FIG. 6 illustrates a bottom view of a component 400 (such as a panel), according to an embodiment of the present disclosure. The compensation nut fastener assembly 100 (shown in FIGS. 1-5) is configured to securely couple to the component 400. Referring to FIGS. 1-6, the top surface of the first nut 102 is configured to abut into a bottom surface 202 of the component 200. It is to be understood that the orientations may be inverted, such that the compensation nut fastener assembly 100 is above the component 400, in which case an upper surface of the first nut 102 abuts into a bottom surface of the component, or in various other orientations (for example, laterally oriented with respect to one another). The terms “top” and “bottom” are merely used with respect to orientations shown in the Figures.

The component 200 includes a channel 203 that is configured to be axially aligned with the fastener-receiving channel 111 of the first nut 102. That is, the first nut 102 connects to the component 200 such that the channel 203 is axially aligned with the fastener-receiving channel 111.

The component 200 includes one or more stop members, such as stops 204 that are configured to engage the protuberances 130 of the first nut 102. In at least one embodiment, the stops 204 may be barriers (such as tabs, studs, and/or the like) extending from the surface 202. In at least one other embodiment, the stops 204 may be holes or recesses 205 (as shown in FIG. 6) that are formed into surface 202 and/or through the component 200.

Each protuberance 130 provides a rigid rotational stop upon engaging a stop 204. For example, as the first nut 102 is urged into the surface 202, the protuberances 130 may rotate over the surface 202. As the protuberances 130 are rotated into the stops 204, at least portions of the protuberances 130 (such as the blunt leading ends 140) extend into the recessed areas (for example, deflect into the recessed areas) or engage the barriers of the stops 204. In each embodiment, as the stop members of the compensation nut fastener assembly 100 (such as the protuberances 130) engage the stop members of the component 200 (such as the stops 204), the interaction therebetween ceases rotational motion of the first nut 102 relative to the component 200. As such, the stop members of the compensation nut fastener assembly 100 cooperate with the stop members of the component 200 to rotationally constrain the first nut 102 relative to the component 200.

In at least one embodiment, the stops 204 are or include recessed areas 205 (as shown in FIG. 7) that retain the protuberances 130, thereby providing a barrier or stop past which the protuberances 130 are unable to rotate. Accordingly, the interaction between the protuberances 130 and the recessed areas of the stops 204 resists further rotation, thereby rotationally constraining the first nut 102 relative to the component 200.

As described, the stop members (for example, the protuberances 130) of the first nut 102 provide a rotational stop upon contacting one or more stop members (for example, the stops 204) of the component 200, and allow a fastener (such as a screw or bolt) to overcome torque caused by the interference fit between a fastener and the torque clip 114. The positive stop between the protuberance(s) 130 and the stop(s) 204 may be provided 90 degrees from a direction of fastener installation and prevents, minimizes, or otherwise reduces further expansion of the compensation nut assembly 100. As such, embodiments of the present disclosure provide compensation nut fastener assemblies that may be used in semi-rigid panel applications such as plastic and/or in which mating panels have potential to move, thereby maintaining the original joint tolerance distance between the two mating surfaces, and eliminating, minimizing, or reducing any unforeseen or unwanted misalignment and/or deformation.

FIG. 7 illustrates a bottom view of a component 200, according to an embodiment of the present disclosure. In this embodiment, the stops 204 may be linear channels 205. Referring to FIGS. 1-5 and 7, as the protuberances 130 are rotated into the channels 205, the blunt leading ends 140 extend into the channels 205 and abut into interior walls that define at least portions of the channels 205. As such, the protuberances 130 are trapped in the channels 205, thereby preventing further rotation of the first nut 102 in a rotational direction that caused the protuberances 130 to engage the stops 204.

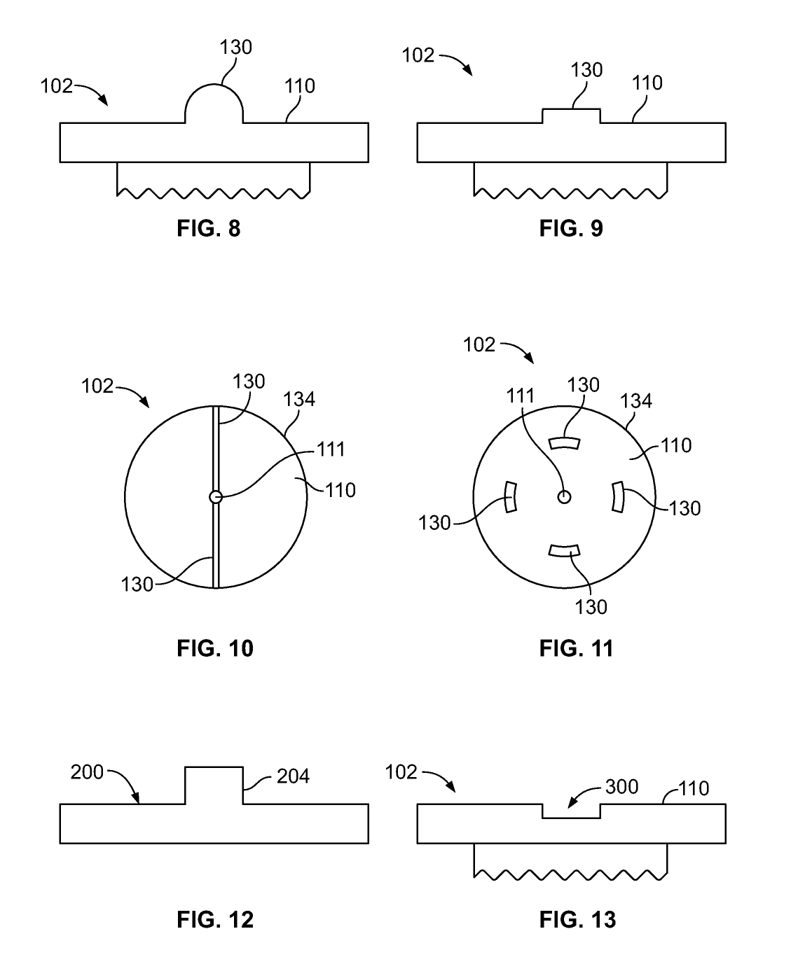

FIG. 8 illustrates a lateral view of a protuberance 130 extending from the first nut 102, according to an embodiment of the present disclosure. In this embodiment, the protuberance 130 may be or include a rounded member, such as a semispherical bump.

FIG. 9 illustrates a lateral view of a protuberance 130 extending from the first nut 102, according to an embodiment of the present disclosure. In this embodiment, the protuberance 130 may be or include a block structure. Optionally, the protuberance 130 may be sized and shaped differently than shown. For example, the protuberance 130 may be shaped as a pyramid, cylinder, hexagonal ridge, or the like.

FIG. 10 illustrates a top view of the first nut 102, according to an embodiment of the present disclosure. In this embodiment, the protuberances 130 may be linear ridges that extend between the channel 111 and the outer edge 134. The relatively long ridges provide a robust and secure stop in relation to a stop member of a component. By utilizing lengthy stop ridges as shown in FIG. 10, there is less need to precisely locate reciprocal stop members on a component, as the stop ridges will engage the reciprocal stop members on the component no matter where they are located within a radius of the collar 110.

FIG. 11 illustrates a top view of the first nut 102, according to an embodiment of the present disclosure. In this embodiment, multiple protuberances 130 may be inwardly-disposed from the outer edge 134.

FIG. 12 illustrates a lateral view of the component 200 according to an embodiment of the present disclosure. In this embodiment, the stop 204 may be or include an upstanding barrier that is configured to abut into the protuberance(s) 130 (such as any of those described above) of the first nut 102 (shown in FIGS. 1-5 and 8-11).

FIG. 13 illustrates a lateral view of the first nut 102, according to an embodiment of the present disclosure. In this embodiment, the first nut 102 may include a stop member in the form of a hole or recess 300. As the first nut 102 rotates relative to the component 200 (shown in FIG. 12), the upstanding stop 204 of the component 204 extends into the recess 300, and is trapped therein, thereby preventing further rotation of the first nut 102 relative to the component 200.

As described above, embodiments of the present disclosure provide fastening systems that include a compensation nut fastener assembly 100 (such as any of those described with respect to FIGS. 1-5, 8-11, and 13) and one or more components 200 (such as any of those described with respect to FIGS. 6, 7, and 12) that are configured to resist rotational motion therebetween after one or more stop members of the first nut 102 (such as the protuberances 130 or recesses 300) engage one or more stop members of the component (such as recesses, channels, barriers, or the like). The interaction between the compensation nut fastener assembly 100 and the component 200 rotationally constrains the first nut 102 of the compensation nut fastener assembly 100 relative to the component 200.

Embodiments of the present disclosure provide compensation nut fastener assemblies that securely and reliably connect to one or more components. Embodiments of the present disclosure provide compensation nut fastener assemblies that are configured to securely and reliably connect semi-rigid or soft components together.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A compensation nut fastener assembly comprising:
a first nut;
a second nut that is adjustably coupled to the first nut; and
at least one first stop member that is configured to cooperate with at least one second stop member of a component to rotationally constrain the first nut relative to the component.

2. The compensation nut fastener assembly of claim 1, wherein the first nut comprises the at least one first stop member.

3. The compensation nut fastener assembly of claim 1, wherein the first nut comprises a component-abutting collar, and wherein the at least one first stop member extends outwardly from the component-abutting collar.

4. The compensation nut fastener assembly of claim 3, wherein the at least one first stop member is proximate to an outer edge of the component-abutting collar.

5. The compensation nut fastener assembly of claim 3, wherein the at least one first stop member comprises:
a root connected to a surface of the component-abutting collar; and
a ramped segment extending from the root at an angle above the surface, wherein the ramped segment includes a blunt leading end that connects to the surface.

6. The compensation nut fastener assembly of claim 1, wherein the at least one first stop member comprises at least one protuberance.

7. The compensation nut fastener assembly of claim 1, wherein the at least one second stop member comprises at least one recess or at least one hole.

8. The compensation nut fastener assembly of claim 1, wherein the at least one first stop member comprises at least one lanced tab.

9. The compensation nut fastener assembly of claim 1, wherein the at least one first stop member comprises a plurality of first stop members.

10. The compensation nut fastener assembly of claim 1, wherein the at least one first stop member is configured to rotate into engagement with the at least one second stop member to rotationally constrain the first nut relative to the component.

11. The compensation nut fastener assembly of claim 1, wherein the first nut comprises a fastener-receiving channel that is configured to receive a portion of a fastener.

12. The compensation nut fastener assembly of claim 1, wherein the first nut is threadably coupled to the second nut, and wherein the first nut is configured to threadably retain a fastener.

13. A fastening system comprising:
a compensation nut fastener assembly including:
a first nut;
a second nut that is adjustably coupled to the first nut; and
at least one first stop member; and
a component including at least one second stop member, wherein the at least one first stop member cooperates with the at least one second stop member to rotationally constrain the first nut relative to the component.

14. The fastening system of claim 13, wherein the first nut comprises the at least one first stop member.

15. The fastening system of claim 13, wherein the first nut comprises a component-abutting collar, and wherein the at least one first stop member extends outwardly from the component-abutting collar, wherein the at least one first stop member is proximate to an outer edge of the component-abutting collar, wherein the at least one first stop member comprises:
a root connected to a surface of the component-abutting collar; and
a ramped segment extending from the root at an angle above the surface, wherein the ramped segment includes a blunt leading end that connects to the surface.

16. The fastening system of claim 13, wherein the at least one second stop member comprises at least one recess or at least one hole.

17. The fastening system of claim 13, wherein the at least one first stop member rotates into engagement with the at least one second stop member to rotationally constrain the first nut relative to the component.

18. The fastening system of claim 13, wherein the first nut is threadably coupled to the second nut, and wherein the first nut is configured to threadably retain a fastener.

19. A fastening system comprising:
a compensation nut fastener assembly including:
a first nut including a component-abutting collar, a fastener-receiving channel that is configured to receive a portion of a fastener, and a plurality of first stop members extending outwardly from the component-abutting collar;
a second nut that is adjustably coupled to the first nut, wherein the first nut is threadably coupled to the second nut, and wherein the first nut is configured to threadably retain a fastener; and
a component including a plurality of second stop members, wherein plurality of first stop members cooperate with the plurality of second stop members to rotationally constrain the first nut relative to the component, wherein the plurality of first stop members are configured to rotate into engagement with the plurality of second stop members to rotationally constrain the first nut relative to the component.

20. The fastening system of claim 19, wherein each of the plurality of first stop members comprises:
a root connected to a surface of the component-abutting collar; and
a ramped segment extending from the root at an angle above the surface, wherein the ramped segment includes a blunt leading end that connects to the surface, and
wherein the each of the plurality of second stop members comprises at least one recess or at least one hole.
